(19) United States
(12) Patent Application Publication
(10) Pub. No.: US 2011/0231887 A1
(43) Pub. Date: Sep. 22, 2011

(54) METHODS AND SYSTEMS FOR AUDIO-VIDEO CLIP SHARING FOR INTERNET-DELIVERED TELEVISION PROGRAMMING

(76) Inventors: R. Michael Peters West, Colchester, VT (US); Robert Francis Shambro, Las Vegas, NV (US)

(21) Appl. No.: 13/045,377

(22) Filed: Mar. 10, 2011

Related U.S. Application Data
(60) Provisional application No. 61/312,431, filed on Mar. 10, 2010.

(51) Int. Cl. H04N 7/173

(52) U.S. Cl. 725/116

(57) ABSTRACT

Methods, apparatus, and systems for audio-video clip sharing for Internet-delivered television programming and sharing audio-video clips within a content distribution network. Initially, an audio-video clip creation message including an identification of a content item, an audio-video clip start index, an audio-video clip end index, and/or a user comment may be received at a server from a first client communicatively coupled to the server. An audio-video clip notification message including means for a recipient to request playing of an audio-video clip via the second client may then be sent from the server to a recipient. Upon receipt of a request to play the audio-video clip from the second client, the server may provide the audio-video clip to a second client.

### RELATED APPLICATION

This application is a NONPROVISIONAL of, claims priority to, and incorporates by reference U.S. Provisional Patent Application 61/312,431 filed 10 Mar. 2010.

### FIELD OF THE INVENTION

The present invention relates to methods and systems for sharing audio-video clips among subscribers to television programming delivered via the Internet or other computer-based networks.

### BACKGROUND

In the past, when friends wanted to share video content, they either had to share entire audio/video files (e.g., via email or other means) or share links that pointed to locations where such files could be found (e.g., uniform resource locators (URLs) that pointed to web sites where the video content of interest was hosted). Neither is an efficient means of sharing video content. In the case where entire files had to be shared, the size of such files is often more than can be conveniently handled by some email inboxes. Further, the sharing of content in this fashion may be an infringement of intellectual property rights of others. In the case of sharing URLs that direct a recipient to a web site or other location where content may be hosted, there is always the possibility that the URL will no longer be active, or the content may have been removed by the time the recipient tries to view it.

### SUMMARY

Methods and systems for audio-video clip sharing for Internet-delivered television programming and sharing audio-video clips within a content distribution network are herein disclosed. Exemplary content distribution networks include a television content distribution network, a hybrid fiber coaxial cable content distribution network, a satellite content distribution network, a local area network (LAN) content distribution network, a wireless LAN (WLAN) content distribution network, and an Internet based content distribution network.

Initially, an audio-video clip creation message for the creation of an audio-video clip may be received at a server from, for example, a first client communicatively coupled to the server. The audio-video clip creation message may include, for example, an identification of a content item, an audio-video clip start index, an audio-video clip end index, and/or a user comment. On some occasions, the content item may be marked so that it is not deleted from the server until the recipient views the audio-video clip.

An audio-video clip notification message may then be sent from the server to, for example, a second client communicatively coupled to the server. The audio-video clip notification message may include, for example, the user comment and/or means for a recipient to request playing of an audio-video clip via the second client.

Upon receipt of a request to play the audio-video clip from the second client, the server may provide the audio-video clip to the second client. The audio-video clip may include, for example, a portion of the content item originating at the audio-video clip start index and terminating at the audio-video clip end index.

In one embodiment, a community of recipients may be generated by using, for example, received contact information for two or more recipients of the audio-video clip or second clients. The contact information may be received via any source of such information, such as, a contact list associated with the user, a contact list associated with the first or second client, and/or a contact list available via the server.

In another embodiment, a recommendation and/or a comment regarding the audio-video clip may be received at the server from, for example, the first client. The received recommendation and/or comment may be associated with the audio-video clip and provided to the second client when, for example, the audio-video clip notification message is provided to the second client and/or the recipient views the audio-video clip via the second client.

In a further embodiment, the user may be associated with a user account with, for example, the content distribution network and the user account may be updated to, for example, indicate receipt of the audio-video clip notification message, the sending of the audio-video clip notification message, a receipt of the audio-video clip notification message by the second client, and/or a viewing of the audio-video clip by the recipient. Likewise, on some occasions, the recipient may be associated with a recipient account with, for example, the content distribution network and the recipient account may be updated to indicate receipt of the audio-video clip notification message and/or a viewing of the audio-video clip by the recipient. In some cases, it may be determined whether the recipient has sufficient subscription rights with the content distribution network, via, for example, their recipient account, to view the audio-video clip. When the recipient does not have sufficient subscription rights with the content distribution network, an opportunity for the recipient to purchase subscription rights sufficient to view the audio-video clip and such purchased rights may be provided to the recipient.

In yet another embodiment, the audio-video clip may be provided to a plurality of second clients and statistics regarding the audio-video clip may be gathered at, for example, the server. Exemplary statistics include the number of times the audio-video clip is viewed via the second clients, the number of second clients the audio-video clip is provided to, a rating of the audio-video clip, and whether the audio-video clip is forwarded by a second client to a third client. In some cases, a popularity of the audio-video clip may be determined based on the gathered statistics.

On some occasions, when the audio-video clip is provided to a plurality of second clients, a rating of an audio-video clip may be received from two or more of the second clients. The rating may be a qualitative assessment or evaluation of the audio-video clip by a recipient who viewed the audio-video clip via a second client. Exemplary ratings include a numerical rating (e.g., on a′scale of 1-5 or 1-10), an image (e.g., an emoticon which reflects a user's feeling or expression regarding the audio-video clip) a term, such as good, bad, excellent, or fair, a combination of terms and/or any combination of the foregoing. In some cases, the received ratings may be summarized and the summary may be, for example, included in the audio-video clip notification message and/or provided to the second client upon receipt of a request for the audio-video clip by the server.

In some embodiments, a plurality of audio-video clips may be shared and a characteristic of each audio-video clip included in the plurality of audio-video clips may be determined. An audio-video clip library including the plurality of audio-video clips may then be generated such that the audio-video clips included in the library are organized according one or more determined characteristics of each respective audio-video clip. On other occasions, two or more audio-video clips may be aggregated together into a composite audio-video clip.

Exemplary systems for sharing audio-video clips within a content distribution network may include a first client and a second client communicatively coupled to a server. The first client may be configured to transmit an audio-video clip creation message to the server. The audio-video clip creation message may include an identification of a content item, an audio-video clip start index, and/or an audio-video clip end index. The server may be configured to, for example, send an audio-video clip notification message to the second client, receive a request to play the audio-video clip from the second client, and provide the audio-video clip to the second client. The audio-video clip notification message may include means for a recipient to request playing of an audio-video clip via the second client. In most cases, the audio-video clip may comprise a portion of the content item originating at the audio-video clip start index and terminating at the audio-video clip end index. The second client may be configured to transmit the request to play the audio-video clip to the server and receive the audio-video clip provided by the server.

Exemplary apparatus for sharing audio-video clips within a content distribution network may be configured to receive an audio-video clip creation message for the creation of an audio-video clip from a first client. The audio-video clip creation message may include, for example, an identification of a content item, an audio-video clip start index, and an audio-video clip end index. The apparatus may be further configured to send an audio-video clip notification message to a second client. The audio-video clip notification message may include, for example, means for a recipient to request playing of an audio-video clip via the second client. When the apparatus receives a request to play the audio-video clip from the second client, the apparatus may be further configured to provide the audio-video clip, comprising a portion of the content item originating at the audio-video clip start index and terminating at the audio-video clip end index to the second client.

### BRIEF DESCRIPTION OF THE DRAWINGS

The present invention is illustrated by way of example, and not limitation, in the figures of the accompanying drawings, in which:

FIG. 1 illustrates an example of a network configured in accordance with an embodiment of the invention for delivering television content over the Internet;

FIG. 2 illustrates an example of a set-top box configured for use in a network such as that depicted in FIGS. 1; and

FIG. 3 illustrates an example of a process for sharing video audio-video clips among subscribers to television programming delivered via the Internet or other computer-based networks in accordance with an embodiment of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

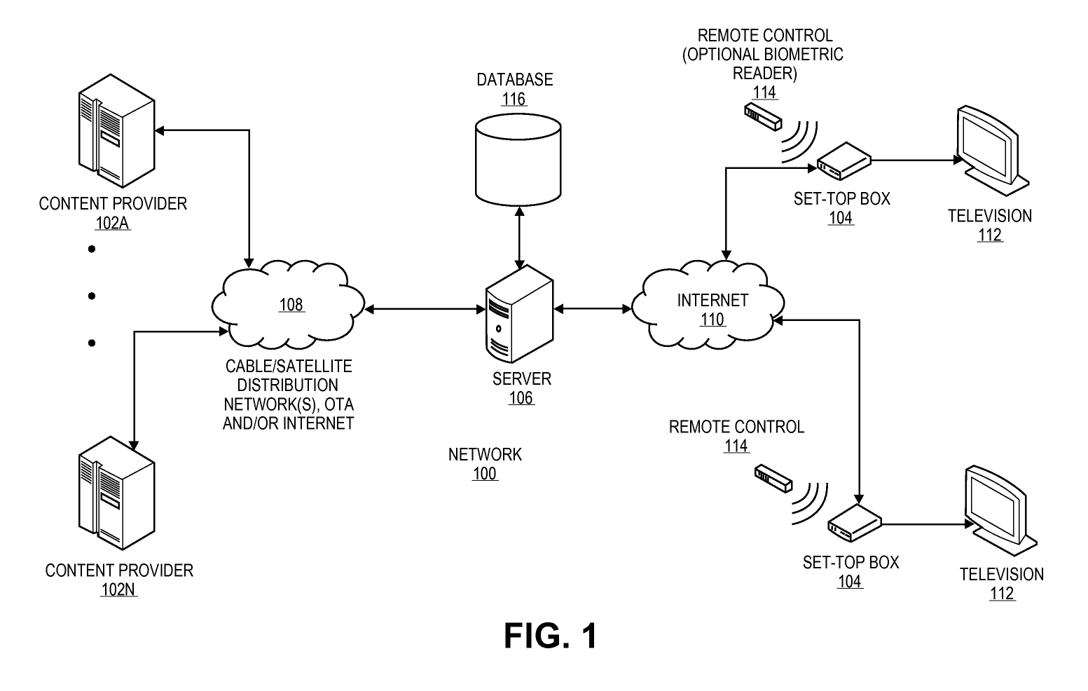

Described herein are methods and systems for sharing video audio-video clips among subscribers to television delivered via the Internet or other computer-based networks or via conventional cable (i.e., hybrid fiber coax) or satellite television networks. Referring first to FIG. 1, an example of a network 100 configured for delivery of television content via the Internet or other computer-based network in accordance with embodiments of the invention is shown. As indicated above, however, the present invention is equally applicable to other television content delivery means, including cable and/or satellite distribution means, and so the following description is intended only as an example of the environment within which the methods and systems that comprise the invention may be implemented. The television content is delivered from various service providers 102A-102N, preferably on a user-defined, à la carte basis, to one or more subscribers, each equipped with a set-top box 104. That is, subscribers to an Internet-delivered television service are each able select their own service offerings. i.e., each subscriber may select his/her own set of television channels instead of having to select prepackaged channel/content offerings designed by a cable, satellite or other service provider. In this way, the subscribers may choose any number of television channels, in any combination, and pay subscription fees solely according to their selections.

This à la carte service offering is made possible by collecting or channeling the television content from the many service providers 102A-102N at/through a server 106 (note, although only one server 106 is illustrated, it should be appreciated that this one server may represent many servers, arranged in central or distributed fashion, in order to accommodate a large subscriber base—for example, such servers may be organized as a central cloud and/or may be distributed geographically or logically to edges of a network in order to minimize service latencies; in either instance, various content may be replicated across the servers that make up the distribution network). Server 106 may receive the content via any of a number of means 108, including conventional cable or satellite television distribution means, over-the-air broadcast, or via one or more computer-based networks, such as the Internet. The content is delivered from server 106 to the various set-top boxes 104 via the Internet 110. Server 106 stores this content (either itself or in attached storage) and may distribute the content for retention on/by other servers within the network. The content is retained for a period of time (which may vary depending on the content, the content providers' wishes, the available storage space, the popularity of the content, etc.) allowing such stored content to be accessed by subscribers at a later time. In this way, the network may operate as an on-line digital video recorder. The television content includes television programming (e.g., both stored and live programming), Internet-based content (including subscriber-generated content), and metadata that includes information about the programming and other content (including, but not limited to, episode names, dates and times of broadcast, etc.).

Each set-top box is communicatively coupled to server 106 (e.g. via a local area network (LAN) using either a wired or wireless connection to a modem or similar equipment that couples the LAN to the Internet in order to exchange data therewith, and, in turn, delivers the content to an associated television or monitor 112 that is communicatively connected to the set-top box (e.g., via a wired or a wireless connection). Individual channel selection may be made via a wireless remote control 114 that is communicatively coupled to a respective set-top box. Selection may be via the electronic program guides discussed below, and/or via hard buttons or other user-manipulable selectors (rocker switches, touch screens, etc.) present on the remote control. The remote control may optionally be fitted with a biometric reader, such as a fingerprint reader, for use in identifying the user holding or operating the remote control. The use of biometric readings facilitated by such devices allows for the generation and presentation of customized electronic program guides for the user. Of course, user identity may be established in other ways, for example using a log-in process and/or using other biometric readings taken by sensors associated with the remote control and/or the set-top box (or even a separate computer system or appliance communicatively coupled to the set-top box).

Server 106 is also communicatively coupled to a database or other storage means 116. This database may be used to store subscriber information, such as subscriber profiles, subscriber channel selections, subscriber-customized electronic program guide preferences, copies of television content (for on-demand viewing, etc.), and other information. As noted above, server 106 (in some cases, together with other servers and associated data storage devices) retains content for a period of time, allowing it to be accessed by subscribers in an on-demand or time-shifted fashion. The subscriber channel selection information may include information regarding current channels subscribed to by a subscriber, gifted channels provided to others by a subscriber, one-time channel subscriptions for on-demand viewing, etc.

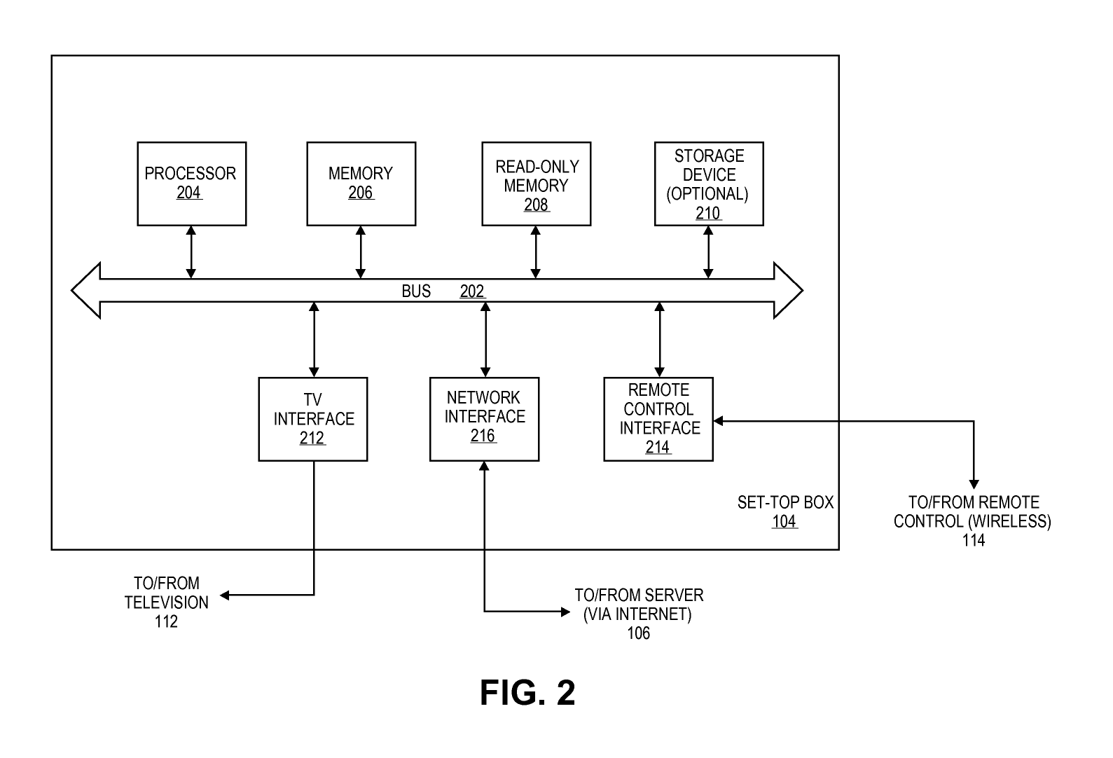

FIG. 2 illustrates features of a set-top box 104 in greater detail. Note that the example in FIG. 2 is intended only as one possible set-top box configuration and is not intended to limit the scope of the present invention in any way. Many of the features and functions provided by the elements described below could be integrated on a single system-on-a-chip or could be distributed over more or fewer modules that are discussed herein. Therefore, the precise hardware configuration of the set-top box is not critical to the present invention. It should also be noted that the use of set-top box 104 devices in the network 100 in FIG. 1 is merely illustrative, in that it would be recognized by those familiar with, and/or skilled in, the art that the functions provided by a set-top box 104 could be integrated within, or distributed across, other or different components of the network 100. For example, modern consumer electronics devices such as televisions, optical disc players, DVRs, home theater systems, and the like are available with “Internet Enabled” or “Internet Ready” capabilities. Such devices would integrate some or all of the functionality of a set-top box 104 and therefore potentially eliminate the need for such a set-top box 104 within network 100.

In the illustrated example, set-top box 104 includes a bus 202 or other communication mechanism for communicating information, and a processor 204 coupled with the bus 202 for processing information. The set-top box also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Set-top box 104 further includes a read only memory (ROM) 208 or other static storage device coupled to the bus 202 for storing static information and instructions for the processor 204. An optional storage device 210, such as a magnetic disk or flash memory, may be provided and coupled to the bus 202 for storing (at least temporarily) television and/or electronic program guide (EPG) content and instructions (e.g., the operating system for the set-top box, user EPG preferences, etc.). If present, storage device 210 (which may, in some instances, be an external storage device or a combination of an internal and an external storage device) may facilitate the use of the set-top box as a digital video recorder (DVR).

According to one embodiment of the invention, the processor (or other application specific hardware) 204 executes sequences of instructions contained in main memory 206 in order to decode (or encode) the audio/video content for presentation via television 112 and produce the customized on-screen EPGs, which may be overlaid or otherwise presented via the television 112. Such instructions may be read into main memory 206 from another computer-readable medium, such as storage device 210 or ROM 208. In alternative embodiments, hard-wired circuitry may be used in place of or in combination with computer software instructions to implement the invention. Thus, embodiments of the invention are not limited to any specific combination of hardware circuitry and software.

Set-top box 104 may be coupled to television 112 via a television interface 212. Television interface may correspond to any of a number of conventional interfaces such as a high definition multimedia interface (HDMI) or other interface. An input device, such as the remote control 114, is communicatively coupled to the bus 202 for communicating information and command selections to the processor 204 via a remote control interface 214. Such an interface may be an infra-red (IR) or other interface. The input device may preferably be configured to permit manipulation of an on-screen cursor along at least two axes, e.g., a first axis (e.g., x) and a second axis (e.g., y), allowing the device to specify positions in a two-dimensional plane.

Set-top box 104 also includes a network interface 216 coupled to the bus 202. Network interface 216 provides a two-way data communication path with server 106. For example, network interface 216 may be a wired or wireless local area network (LAN) interface to provide a data communication connection to a compatible LAN (such as a LAN that uses an IEEE 802.11a/b/g/n communication protocol). Set-top box 104 can send messages and receive data, including television content and EPG information, firmware updates, and other information through network interface 216.

The present delivery system for television programming provides opportunities for creating and leveraging user communities. Such communities may be developed along any of several lines, for example, by allowing subscribers to identify their friends or contacts, by allowing subscribers to upload their address books and using the entries therein, by creating communities of users that watch certain television programs, genres of programs, actors and/or directors, etc. Further, because the set-top boxes 104 provide two way communication with the server 106, an in-system messaging platform may be deployed across these components to allow for messaging between different subscribers via the set-top boxes.

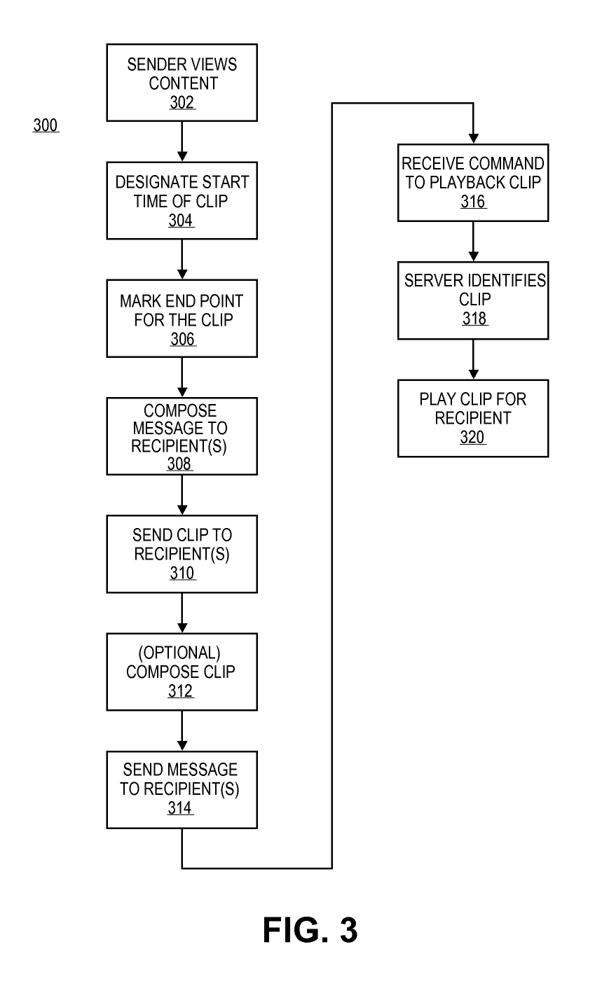

Referring now to FIG. 3, one such form of messaging may involve the inter-subscriber exchange of video audio-video clips (e.g., selected segments of content from television programs, movies and the like), without having to actually send the video content itself between set-top boxes. In the past, when friends wanted to share video content, they either had to share entire audio/video files (e.g., via email or other means) or share links that pointed to locations where such files could be found (e.g., uniform resource locators (URLs) that pointed to web sites where the video content of interest was hosted). Neither is an efficient means of sharing video content. In the case where entire files had to be shared, the size of such files is often more than can be conveniently handled by some email inboxes. Further, the sharing of content in this fashion may be an infringement of intellectual property rights of others. In the case of sharing URLs that direct a recipient to a web site or other location where content may be hosted, there is always the possibility that the URL, will no longer be active, or the content may have been removed by the time the recipient tries to view it.

Overcoming these kinds of limitations, the present invention provides for sharing of video content by passing audio-video clip information from a sender's set-top box to the server, where it can be used to prepare an audio-video clip. The server, in turn, can pass a message to the intended recipient of the audio-video clip and then play back the audio-video clip at the request of the recipient (e.g., on a platform, such as a set-top box/or other instrumentality associated with or designated by the recipient). The video content itself need not be delivered from the sender's set-top box to the recipient's set-top box, nor does the recipient need to rely upon potentially outdated directions to the audio-video clip in order to view it.

As shown in FIG. 3, a method 300 of sharing video audio-video clips begins, at 302, with the sender viewing content on his/her television. The content is provided via the system described above through a set-top box 104. The viewer is a subscriber to the content (e.g., to the television channel or network over which the content is being provided).

If this is the first time the content is being provided from server 106, the content is stored by the server (e.g., in database 116). Alternatively, if the content has been previously stored by server 106, it may be being played back as part of a video-on-demand request or a time-shifted playback requested by the subscriber (e.g., in a server-based digital video recorder embodiment of the present system). In either instance, if the viewer wishes to send an audio-video clip of the content to his/her friend, the process is straightforward.

As the viewer is watching, he/she can designate the start time of an audio-video clip to be sent to the recipient(s) 304. In some cases, this may involve the viewer rewinding the playback to a point at which he/she intends the audio-video clip to begin. Such rewinding (as well as other trick modes) may be implemented either at the set-top box (e.g., by providing temporary storage of the content being viewed at the set-top box) or at the server 106. In either case, the start index of the video audio-video clip may be marked (e.g., as a time code or other indicator) by the viewer using an appropriate control from the remote control or similar means (e.g., set-top box controls or out-of-band controls from a computer system networked with the set-top box, etc.).

Next, the viewer allows the audio-video clip to play (or fast forwards) to a desired end point for the audio-video clip 306. Similar to the marking of the start index, the end index may be indicated via an appropriate control from the remote control or other means. The start and end indices may be stored by the set-top box until the complete message is ready to be sent, or they may be stored at the server (e.g., associated with the user's account or profile).

In either event, the viewer is then afforded an opportunity to compose a message to the recipient(s) 308. This may be done immediately after marking the end point of the audio-video clip or may be done at a later time convenient to the viewer. For example, the viewer may want to designate several audio-video clips out of the same program and so may do as he/she is watching the program and then afterwards compose a composite message for the recipient(s) that covers all of the various audio-video clips. The message may be composed using a keyboard which is part of the remote control, or is a separate keyboard, or is a soft keyboard that is brought up on-screen and used by manipulating the remote control or other means.

Once the message has been composed, the user sends the audio-video clip message to the recipient(s) by executing an appropriate command via the remote control 310 or similar means. The recipient(s) may be selected from an address book or other contact list, much in the same fashion as emails are customarily addressed. The address list may be accessible, from, for example, data stored in set-top box 104, on server 106, or elsewhere, via an on-screen menu using the remote control. Optionally, the sender may be allowed the opportunity to preview the audio-video clip prior to sending it, in case further edits or message comments need to be made.

When the audio-video clip is sent to the recipient(s), no audio/video information is transferred from the viewer's set-top box. Instead, the set-top box sends only the text of the message, along with identifying information for the subject audio/video content (of which the intended audio-video clip is a component), and the start and end indices for the subject audio-video clip to server 106.

At the server, the audio-video clip may be composed at this time 312. For example, the audio-video clip may be developed based on the start and stop indices and stored awaiting playback for the recipient(s). Alternatively, the audio-video clip itself need not be composed, but the program from which the audio-video clip is taken may be marked so that it is not deleted until the audio-video clips have been viewed by the recipient(s). Or, in some instances, the various accounts of the recipient(s) may simply be updated to reflect the fact that audio-video clips have been sent and audio-video clip generation may await response by the recipient(s).

In any event, the server 106 sends the message from the original viewer to the recipient(s) 314. Hereafter, it will be assumed that only one recipient is involved, but the processes discussed herein are applicable to audio-video clips sent to any number of recipients. In sending the message, the server sends the text of the message composed by the viewer, but need not send the start and stop indices. Instead, the server may include with the message some information about the program from which the audio-video clip was taken so that the recipient can determine whether or not he/she wishes to view the audio-video clip and when.

The message may be provided to the recipient immediately, via an on-screen notification through the recipient's set-top box, or may simply be indicated in an electronic mailbox accessible by the recipient. In the latter case, the recipient may be notified of the availability of a new message in his/her mailbox. The electronic mailbox may exist on the server or the recipient's set-top box, or both.

At some point, after reading the message the recipient will instruct the server to play back the audio-video clip 316. This may be done through an appropriate command via the remote control, for example by selecting an on-screen graphical element that results in a playback command being passed to the server. The instruction may take any of several forms and may include information that allows the server to identify the original audio-video clip parameters, such as the program identification, the start index and the end index. For example, each in-system audio-video clip message may have a unique identifier that is passed back to the server when a recipient instructs playback of an audio-video clip. Using this identifier, the server can recall either the previously stored audio-video clip, or can recall the original message from the sender to obtain that information, or other information sufficient to allow the server to identify the subject program and the start and stop indices for the audio-video clip 318.

Once the server has identified the audio-video clip, the server plays the audio-video clip for the recipient 320. This may involve playing a previously composed audio-video clip, or simply playing the designated portion of the previously stored program from the audio-video clip start index to the audio-video clip end index. Either way, the subject audio-video clip is played for the recipient. If multiple audio-video clips are involved, they may be played back serially one after the other, or may be played back only in response to individual commands sent by the recipient.

Many variations, refinements, and optimizations of the above-described process may be practiced in accordance with the present invention. For example, the marking of start and stop indices may be performed using single button operations by a viewer. That is, designated hard or soft buttons on the remote control may be invoked in order to perform the audio-video clip selection operations. Alternatively, or in addition, the user may be afforded an opportunity to select start and stop indexes from a graphical representation of the content as a timeline or series of frames presented on the television (e.g., in the fashion of a video editor) using an on-screen cursor or similar tool.

Further, in some instances, both the sender and the recipient need to be subscribers to the content provider before the recipient will be provided access to the audio-video clip. In other embodiments, however, the sender may be permitted to purchase rights to the audio-video clip for the recipient. Or, the sender may purchase a “audio-video clip right” on his/her own account that allows the sending of audio-video clips to recipients that are not subscribers to the particular content provider from which an audio-video clip is obtained. In still further instantiations, subscribers may have general “audio-video clip accounts” that can be debited whenever they receive and view audio-video clips from content providers to which they do not subscribe. In still other cases, audio-video clips may be provided free of charge in exchange for the recipient viewing advertisements or the like. The server 106, or a separate billing server (not shown) is configured to ensure that the appropriate charges are levied and collected in conjunction with the exchange of audio-video clips in the present system.

In some instances, as an aspect of the social network established among users of the present system, server 106 may maintain audio-video clip ratings, which are indicative of the popularity of audio-video clips. Such popularity may be measured, in one example, by the number of times audio-video clips are forwarded between users (in the fashion of chain letters or the like). As the number of such forwardings increases, audio-video clip popularity ratings may be increased. Such ratings may be maintained in billboard fashion at the server, available for all users to see. As a result, users may view audio-video clips (but not the messages accompanying audio-video clips unless permitted by the message sender) that had not necessarily been directed to them. The same account rules regarding subscriptions and the like would have to be observed. In addition, ratings may be assigned by a user at the time an audio-video clip is created, and also by a recipient after an audio-video clip has been viewed. These statistics too could be aggregated and averaged, and provided for use/review by others.

Audio-video clips may also be aggregated, either by individual users or by the server 106, to create composite audio-video clips. The composites may be from a single program, or from multiple programs that share one or more common traits, or that are “favorites” of a particular user or group of users. Audio-video clip ratings may be combined with program and/or content provider ratings to form aggregate ratings of programs, networks, etc. Audio-video clip libraries may be maintained to allow users to browse audio-video clips compiled by well-known users in a particular community or as promotional devices.

In order to ensure that intellectual property rights are respected, at the time a user creates an audio-video clip and designates recipients, the server 106 may consult its database and determine whether or not those recipients have sufficient subscription rights to view the audio-video clip. If not, the user creating the audio-video clip may be so advised, and may also be prompted to purchase such rights for the recipient (e.g., as a gift), or to designate the use of a low resolution version of the audio-video clip (or other format) which does not require subscription rights. Alternatively, or in addition, the recipients may be notified that audio-video clips are awaiting their review but that subscription rights or other fees (e.g., one-time fees, day passes, etc.) are required in order to view the audio-video clips (or high resolution or other versions thereof).

Thus, methods and systems for sharing video audio-video clips among subscribers to television programming delivered via the Internet or other computer-based networks have been described. As discussed above, the present invention facilitates a service and community where users can extract portions (audio-video clips) of audio/video programming to share with one another, along with recommendations and comments regarding those audio-video clips. The recommendations and/or comments take the form of a small text message to which the audio-video clip attributes are appended. The messages may be shared with designated (by the original viewer) community members or could be made accessible to all (or a designated group or groups of) the community via a bulletin board or similar means. Importantly, only community members who have rights (by subscription or otherwise, e.g., previously or subsequently purchased/obtained) to access the audio-video clips are able to view same. In some instances, portions of audio-video clips (or low resolution versions of audio-video clips) may be viewable by non-subscribers, as an enticement for those individuals to become subscribers.

In some cases, the messages accompanying the audio-video clips may include one or more still images taken from the audio-video clips so as to indicate the nature thereof. In the case of multiple images, they may be played in serial fashion to emulate a moving picture.

As indicated, senders and recipients can assign ratings to audio-video clips. The ratings may remain associated with the subject audio-video clip and, optionally, with the original program-ratings generated for audio-video clips of any given program may be aggregated as a composite rating for the full program. Alternatively, ratings for audio-video clips from a given program can be aggregated with ratings for other audio-video clips from the same program to develop a so-called “audio-video clip rating” associated with the program. In other words, a given program could have a “program rating” as well as a separate audio-video clip rating. Additionally, audio-video clips of a common program can be aggregated so that in some cases, viewers may choose only to watch the aggregate audio-video clips instead of the complete program. Additionally, if the subject program is part of a series of programs, then the ratings could be further aggregated to create a composite series rating, with subscribers able to investigate ratings and comments for the series as a whole, for specific episodes and for specific portions/audio-video clips within those episodes. Such ratings could even be further aggregated to create a rating for a particular network or channel.

What is claimed is:

1. A method of sharing audio-video clips within a content distribution network, comprising:
receiving at a server, from a first client communicatively coupled to the server, one or more audio-video clip creation messages for the creation of an audio-video clip, said audio-video clip representing at least a portion of an audio-video content item stored at or accessible to the server, the audio-video clip creation messages including an identification of the content item, an audio-video clip start index, and an audio-video clip end index;
sending, from the server an audio-video clip notification message, the audio-video clip notification message including means for a recipient to request playing of the audio-video clip via a second client communicatively coupled to the server; and
upon receipt of a request to play the audio-video clip, providing from the server to the second client the audio-video clip, wherein the audio-video clip comprises a portion of the content item originating at the audio-video clip start index and terminating at the audio-video clip end index.

2. The method of claim 1, wherein the content distribution network is at least one of a television content distribution network, a hybrid fiber coaxial cable content distribution network, a satellite content distribution network, a local area network (LAN) content distribution network, a wireless LAN (WLAN) content distribution network, and an Internet based content distribution network.

3. The method of claim 1, further comprising:
receiving at the server, from the first client, contact information for two or more recipients of the audio-video clip; and
generating at the server a community of recipients using the received contact information.

4. The method of claim 3, wherein the contact information is received via uploading a contact list from a source external to the server.

5. The method of claim 1, further comprising:
marking, by the server, at least one of the content item and the audio-video clip so that it is not deleted from the server until the recipient views the audio-video clip.

6. The method of claim 1, further comprising:
receiving at the server, from the first client, at least one of a recommendation and a comment regarding the audio-video clip;
associating, by the server, the at least one recommendation and comment with the audio-video clip; and
performing at least one of including, by the server, the at least one recommendation and comment in the audio-video clip notification message and providing from the server to the second client the at least one recommendation and comment upon receipt of the request.

7. The method of claim 1, wherein the first client is associated with a first client account within the content distribution network, the method further comprising:
updating, by the server, the first client account to indicate at least one of the receipt of the audio-video clip notification message, the sending of the audio-video clip notification message, a receipt of the audio-video clip notification message by the second client, and a viewing of the audio-video clip by the recipient.

8. The method of claim 1, wherein the recipient is associated with a recipient account with the content distribution network, the method further comprising:
updating, by the server, the recipient account to indicate at least one of receipt of the audio-video clip notification message and a viewing of the audio-video clip by the recipient.

9. The method of claim 1, further comprising:
determining at the server whether the recipient has sufficient subscription rights to view the audio-video clip; and, if not,
providing, by the server, at least one of an opportunity for the recipient to purchase subscription rights sufficient to view the audio-video clip and an opportunity for the creator of the audio-video clip to purchase for the recipient subscription rights sufficient to view the audio-video clip, otherwise facilitating playback of the audio-video clip on the second client.

10. The method of claim 1, wherein the audio-video clip is provided to a plurality of second clients, the method further comprising:
gathering statistics regarding the audio-video clip at the server; and
determining, by the server, a popularity of the audio-video clip based on the gathered statistics.

11. The method of claim 1, further comprising:
receiving a rating of the audio-video clip at the server;
summarizing the received ratings at the server; and
performing at least one of including, by the server, the summary in the audio-video clip notification message and providing from the server to the second client the summary upon receipt of the request.

12. The method of claim 1, further comprising:
aggregating, by the server, two or more audio-video clips together.

13. The method of claim 1, further comprising:
generating, by the server, a composite audio-video clip using two or more audio-video clips from one or more audio-video content items.

14. The method of claim 13 the, further comprising:
determining, by the server, a characteristic of each audio-video clip included in the plurality of audio-video clips; and
generating, by the server, an audio-video clip library including the plurality of audio-video clips, wherein the audio-video clips included in the library are organized according a determined characteristic of each audio-video clip.

15. The method of claim 1, wherein a plurality of audio-video clips are shared.

16. The method of claim 1, wherein the audio-video clip notification message further includes a user comment.

17. The method of claim 1, wherein the audio-video clip notification message is sent to a wireless communication device other than the second client.

18. The method of claim 17, wherein the request to play the audio-video clip is received from the wireless communication device.

19. A system for sharing audio-video clips within a content distribution network, comprising:
a first client communicatively coupled to a server and configured to transmit one or more audio-video clip creation messages for the creation of an audio-video clip to the server, said audio-video clip representing at least a portion of an audio-video content item stored by or accessible to the server, the audio-video clip creation messages including an identification of the audio-video content item, an audio-video clip start index, and an audio-video clip end index; and
the server communicatively coupled to the first client and a second client, and configured to send an audio-video clip notification message to a designated recipient, the audio-video clip notification message including means for the recipient to request playing of an audio-video clip via the second client, receive a request from the recipient to play the audio-video clip, and provide the audio-video clip to the second client, wherein the audio-video clip comprises a portion of the content item originating at the audio-video clip start index and terminating at the audio-video clip end index.

20. The system of claim 19, wherein the server is further configured to determine whether the recipient has sufficient subscription rights to view the audio-video clip and, if not, provide at least one of an opportunity for the recipient to purchase subscription rights sufficient to view the audio-video clip and an opportunity for the creator of the audio-video clip to purchase for the recipient sufficient rights to view the audio-video clip, otherwise facilitating playback of the audio-video clip on the second client.

21. An apparatus for sharing audio-video clips within a content distribution network, said apparatus comprising means for receiving one or more audio-video clip creation messages for the creation of an audio-video clip from a first client, wherein the audio-video clip represents at least a portion of an audio-video content item stored by or accessible to the server and the audio-video clip creation messages include an identification of the content item, an audio-video clip start index, and an audio-video clip end index;
sending an audio-video clip notification message to a recipient, wherein the audio-video clip notification message includes means for the recipient to request playing of an audio-video clip via a second client; and
providing, responsively to a request to play, the audio-video clip to the second client, wherein the audio-video clip comprises a portion of the content item originating at the audio-video clip start index and terminating at the audio-video clip end index.

22. The apparatus of claim 21, wherein said apparatus further comprises means for determining at the server whether the recipient has sufficient subscription rights to view the audio-video clip; and, if not,
providing, by the server, at least one of an opportunity for the recipient to purchase subscription rights sufficient to view the audio-video clip and an opportunity for the creator of the audio-video clip to purchase for the recipient subscription rights sufficient to view the audio-video clip, otherwise facilitating playback of the audio-video clip on the second client.
